(19) United States
(12) Patent Application Publication
(10) Pub. No.: US 2009/0062454 A1
(43) Pub. Date: Mar. 5, 2009

(54) Composition Based on Plasticized PVC Thermoplastic Resins for the Production of Composite Skins for Vehicle Passenger Compartment Parts

(75) Inventors: Ludovic Hardouin-Duparc, Reims (FR); Jeremy Dauchin, Saint-Brice-Courcelles (FR); Jean-Francois Vautrin, Reims (FR); Anne Chabrol, Reims (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/090,538

(22) PCT Filed: Oct. 17, 2006
(86) PCT No.: PCT/FR2006/051046

§ 371 Date: Apr. 17, 2008

(30) Foreign Application Priority Data
Oct. 18, 2005 (FR) 0510581

(51) Int. Cl. C08L 27/06; B29C 41/18

(52) U.S. Cl. 524/569; 264/302

(57) ABSTRACT

The present invention relates to a composition based on plasticized polyvinyl chloride (PVC) thermoplastic resins for producing a layer of a composite structure or skin, said layer being provided on its outer surface with a coating, characterized in that the composition comprises, expressed as percent by weight: —from 40% to 60% of one or more PVC resins with a K value of between 50 and 80. —from 30% to 50% of one or more types of plasticizers, at least one of which is polymeric in nature, or is a heavy monomeric plasticizer, —from 1% to 20% of additives, such as pigments or fillers, stabilizers, antioxidants, processing additives and lubricants. The invention also provides the process for producing these composite skins by moulding, and their use for parts of the passenger compartment of automotive vehicles, such as, in particular, airbag-equipped dashboards.

The present invention relates to compositions based on plasticized polyvinyl chloride (PVC) thermoplastic resins that makes it possible to produce a layer of composite “skins” or multilayers; these composite skins or structures comprise an outer coating or covering and an inner layer according to the invention; these composite skins are used for the passenger compartment parts of motor vehicles, such as, in particular, dashboards equipped with visible airbags (having separate covers) or integrated airbags (also called invisible airbags, i.e. not visible to the driver and the passengers), central consoles and door trims (or door panels).

Another subject of the invention is the process for manufacturing these composite skins by molding.

### PRIOR ART

In the technical field of manufacturing motor vehicle instrument panels it is known to use skins of those panels produced conventionally, especially by the molding technique in which powder is poured into a hot mold, either by rotomolding or by slush molding.

These instrument panels generally comprise an outer imitation leather “skin” which gives the external appearance (in particular the color, pattern, look and feel). Conventionally, the main materials used are polyvinyl chloride (PVC) thermoplastic resins, thermoplastic polyurethanes (TPUs), thermoplastic polyolefins (TPOs) and polyurethanes (PUs).

A foam-based material, in general made from expanded polyurethane or PVC, is used as a backing to provide the properties of flexibility and thermal and sound insulation.

The outer skin is subjected to external attack: scratches, UV radiation, temperature, solvents, etc.

In certain cases, a composite (multilayer) “skin” may be produced so as to provide particular appearance properties, in particular: decoration, color, feel or aging or abrasion resistance.

There are several technologies for producing composite skins:
a) double slush molding, that allows the superposition of two layers made of polyvinyl chloride (PVC) thermoplastic resins of different natures, in order to produce a composite skin; this process is described, in particular, in document WO 02/094610 in the name of the applicant, which describes the production of a composite skin comprising a ductile layer and a brittle layer, for a part of a passenger compartment for an integrated airbag; and
b) the application of at least one coating layer:
   to the finished skin;
   to the surface of a mold, in a skin preproduction step.

There are, in particular, two processes including one known as “in-mold painting” or “in-mold pigmentation” (IMP), such as described in document EP 0 912 312 by the Applicant; this process comprises the following steps:
i) depositing on the surface of a mold a composition A that comprises at least one plasticizer and optionally one or more modifying agents, such as coloring pigments, decorative flakes or a PVC-type thermoplastic resin;
ii) then depositing a composition B that comprises a thermoplastic resin such as PVC, and
iii) heating the mold.

The second process, known as “In-Mold Coating” (IMC) is described, in principle, in document WO 2004/060627, and also in U.S. Pat. No. 6,656,596; the latter document relates to the production of a panel for the inside of a motor vehicle that has a multilayer structure obtained by successively depositing in a mold a coating or covering comprising an aqueous dispersion or a dispersion in a solvent of a polyurethane, a colorant and a crosslinking agent, and a layer containing polyvinyl chloride (PVC) and at least one plasticizer via the slush-molding process.

In the case of the use of the polyurethane coating, one main problem which is faced is that of the migration of the plasticizers contained in the PVC layer through the coating, leading to their exudation which gives a greasy feel to the outer surface of the skin and an unattractive appearance, in particular for the dashboards of motor vehicles; another problem encountered may be the incompatibility between the various additives, such as, in particular, the plasticizers used in the PVC layer and in the coating. Another problem encountered is the migration of amines from the polyurethane in the PVC layer. In order to limit the migration in the polyurethanes, it is possible to increase the crosslinking but then the low-temperature properties are diminished.

The customary plasticizers used are chosen from esters formed from higher alcohols (typically C₈ to C₁₃ alcohols) and organic acids such as, in particular, aromatic acids such as trimellitic acid in order to give trimellitates (for example, octyl trimellitate—TMO), phthalic acid to give phthalates (for example, dibutyl phthalate—DBP, dioctyl phthalate—DOP, diundecyl phthalate—DUP, ditridecyl phthalate—DTDP) or benzoic acid (benzoates); other acids such as, in particular, adipic acid (dioctyl adipate—DOA, diisodecyl adipate—DIDA, ditridecyl adipate (DTDA), oleic acid (butyl oleate), sebacic acid (dioctyl sebacate—DOS, diisodecyl sebacate—DIDS), azelaic acid (dioctyl azelate—DOZ), citric acid (citrates) and phosphoric acid (phosphates) are also used.

Furthermore, the multilayer skins thus obtained meet the specifications of the motor vehicle manufacturers, in particular the demands as regards the opening of an integrated or non-integrated airbag, that is to say opening in a very short lapse of time without projecting particles, for temperatures conventionally between −40° C. and +80° C.

The invention provides a solution to these problems via the optimization of the choice of plasticizer or of the mixture of several plasticizers used in the composition based on polyvinyl chloride (PVC) thermoplastic resins that forms the intermediate layer of a composite skin, that also comprises an outer coating (covering) in direct contact with one of the faces of said plasticized PVC-based layer; this optimization, by suppressing the migration of plasticizers between the PVC layer and the outer coating, improves their compatibility and enables the production of passenger compartment pieces or parts of motor vehicles having an appearance and mechanical properties that conform to the manufacturers' specifications.

The invention relates to a composition based on plasticized polyvinyl chloride (PVC) thermoplastic resins for producing a layer of a composite skin or structure, this layer being equipped with a coating on its outer face, characterized in that it comprises, expressed in weight percent:
from 40 to 60% of one or more PVC resins with a K-value between 50 and 80;
from 30 to 50% of one or more types of plasticizers, of which at least one is of polymeric nature, or is a heavy monomeric plasticizer; and
from 1 to 20% of additives, such as pigments or fillers, stabilizers, antioxidants, processing aids and lubricants.

According to one embodiment, the content of polymeric or heavy monomeric plasticizer is greater than 10 wt % relative to the total amount of plasticizers.

According to one embodiment, the weight ratio of plasticizers to the resin is at least 60/100.

According to one embodiment, the polymeric plasticizer(s) is (are) chosen, in particular, from polyphthalates and polyadipates.

According to one embodiment, other plasticizers are added to the composition, chosen from the group of azelates, trimellitates, sebacates, adipates, phthalates, citrates, benzoates, tallates, glutarates, fumarates, maleates, oleates, palmitates and acetates.

According to one advantageous embodiment, the heavy monomeric plasticizer(s) has (have) a weight-average molecular weight of at least 350.

Among the heavy monomeric plasticizers use is particularly made of ditridecyl adipate (DTDA) and diisodecyl sebacate (DIDS).

The composition according to the invention also relates to mixtures of polymeric plasticizer(s) and heavy monomeric plasticizer(s) such as described above, in very large amounts.

According to one embodiment, the thermoplastic resin is polyvinyl chloride (PVC) obtained by a suspension or microsuspension process, but PVC manufactured in emulsion or in bulk may also be used.

According to one embodiment, the thermoplastic resin comprises a mixture of polyvinyl chloride (PVC) and a compatible polymer chosen from copolymers or terpolymers of vinyl chloride and vinyl acetate (VC/VA) or vinyl chloride and an acrylic derivative (VC/AD), thermoplastic polyurethanes (TPUs), thermoplastic polyetheresters, ethylene/vinyl monomer (EVA) copolymers, ethylene/vinyl monomer/carbonyl terpolymers, melt-processable acrylic elastomers, copolymers with polyamide blocks and polyether blocks or polyether-block-amides, chlorinated or chlorosulfonated polyethylenes, functionalized or unfunctionalized ethylene/alkyl (meth)acrylate or (meth)acrylic acid polymers, MBS core-shell polymers, SBM block terpolymers, PVDF and powdered polyamide resins.

An example of a VC/VA copolymer is Lacovylo from Arkema, an example of a VC/AD copolymer is Vinnolito from Vinnolit, an example of a TPU is Estane® from Goodrich, an example of a thermoplastic polyetherester is Hytrel® from DuPont, an example of a polyether-block-amide is Pebax® from Arkema, an example of an EVA is Evatane® from Arkema, an example of an ethylene/vinyl monomer/carbonyl terpolymer is Elvaloy® from DuPont, examples of functionalized or unfunctionalized ethylene/alkyl (meth)acrylate or (meth)acrylic acid polymers are Lotryl®, Lotader® and Orevac® from Arkema, an example of chlorinated or chlorosulfonated polyethylenes is Tyrin® from DuPont, an example of a melt-processable acrylic elastomer is Alcryn® from Apa, an example of powdered polyamide resins is Orgasol® from Arkema.

These polymers that are compatible with PVC, said to be “alloyed” with PVC, have good low-temperature properties and are capable of conferring a suitable brittleness to the layers thus obtained.

According to one preferred embodiment, the additives added to the composition are chosen from pigments or fillers, lubricants, UV stabilizers, heat stabilizers, processing aids and antioxidants, in amounts between 3 and 10 wt % relative to the composition.

Another subject of the invention is the use of the composition according to the invention, for obtaining a layer of a composite skin or structure, for the passenger compartment parts of motor vehicles, especially dashboards equipped with airbags, the outer surface of said layer being covered with a coating chosen from compositions based on epoxy resin, polyurethane resin, PVC or acrylic resins.

Another subject of the invention is a process for preparing a composite skin for a motor vehicle passenger compartment part according to the invention, characterized in that in a first step the coating is deposited in a mold, and that in a second step the layer obtained from the composition according to the invention is produced by slush molding.

The devices used to carry out such a slush-molding process are well known to persons skilled in the art and use, in particular, air, oil or sand heating systems.

According to one preferred embodiment, the composite skin is composed, successively from the outside (surface visible in the passenger compartment) towards the inside, of:
a coating having a thickness between 10 and 500 microns, preferably between 50 and 150 microns;
a PVC layer having a total thickness between 0.5 and 2 mm, preferably between 0.9 and 1.2 mm; and
an inner layer (support) made of foam having a thickness between 0.5 and 10 mm, preferably between 0.9 and 6 mm.

The coating may be produced from aqueous-based or solvent-based polyurethane compositions, but may also be based on plasticized PVC resins; it is applied by any known technique, in particular by spraying (Airmix or Airless spraying).

Regarding the polymeric plasticizers used, these are understood to mean the products of the reaction and condensation of a carboxylic diacid (in particular, phthalic acid, adipic acid, sebacic acid, etc.) with a diol (ethylene glycol, propylene glycol, butanediol, hexanediol, etc.) or of a mixture of various carboxylic diacids with one or more diols.

When these molecules have reacted, the chain propagation may be stopped by the use of monofunctional carboxylic acids or alcohols.

These polymeric plasticizers, which are preferably chosen from polyphthalates and polyadipates, are characterized by a viscosity in a range from 100 to 8000 mPa·s at 25° C. (measured according to the ASTM D 445 method).

The composition of the PVC layer must perfectly adhere to the coating and to the foam layer.

### 1) EXEMPLARY EMBODIMENTS OF COMPOSITIONS ACCORDING TO THE INVENTION

The following compositions A to F were prepared with PVC resins having a K-value of 70 and with various monomer (or monomeric) plasticizers such as trioctyl trimellitate (TOTM), diundecyl phthalate (DUP), ditridecyl adipate (DTDA) and diisodecyl sebacate (DIDS), and/or polymeric plasticizers such as polyadipates.

The viscosities of these polymeric plasticizers were between 100 and 8000 mPa·s at 25° C. (measured according to the ASTM D 445 method).

Other additives were introduced, such as a lubricant, for instance epoxidized soybean oil (ESO) and also UV stabilizers, heat stabilizers and antioxidants.

Examples A and B correspond to conventional formulae of the prior art that do not conform to the invention.

Example C shows the advantage of introducing a polymeric plasticizer mixture with a conventional monomeric plasticizer, without however conforming to the invention.

Examples E and F show the advantage of polymeric plasticizers used as a mixture with heavy monomeric plasticizers.

Example D shows the advantage of polymeric plasticizers.

Samples of instrument panel skins were prepared from these compositions by the slush-molding process (with heating of the molds via an oil circuit) and they were subjected to various tests explained below.

The migration of the plasticizers was evaluated according to a visual method of quantification: after the production of a skin, a greasy film appeared at the surface quickly or slowly and in greater or lesser amounts (the greater the migration, the more—signs there are).

The brittleness test consisted of a low-temperature impact measurement according to the ASTM D 746-04 standard.

The sample was submerged in a bath of alcohol and ice for 2 minutes, then the impact with a hammer took place.

The gelling test was carried out according to an internal method for determining gelling times, using a thermostated oven (of Metrastat or Werner & Mathis type) and by comparison of the formulae to one another.

The “strips” of powder (thickness: 1 mm) were passed into an oven (set temperature: 240° C. or 220° C.) and were placed on a movable plate: a time gradient was obtained along the plate and it was possible to locate the gelling start time at this temperature.

It was thus possible to compare several products at the same time.

The + sign signifies that the sample is better than the control.

The − sign signifies that the sample is worse than the control.

This gelling test expresses the ease of use of powders obtained from compositions in converters that produce the composite skins.

The preparation of the compositions according to the invention was carried out in conventional installations with introduction of the additives either at the top of the chamber (hot) or at the bottom of the chamber (cold), with final production of powders.

The properties of the various compositions produced are given in Table 1 below:

TABLE 1

| Formula | A | B | C | D | E | F |
|---|---|---|---|---|---|---|
| PVC | 100 | 100 | 100 | 100 | 100 | 100 |
| suspension | | | | | | |
| PVC emulsion | 10 | 10 | 10 | 10 | 10 | 10 |
| Trimellitate | 85 | | 42.5 | | | |
| (TOTM) | | | | | | |
| Polymer | | | 42.5 | 85 | 60 | 65 |
| plasticizers | | | | | | |
| Phthalate | | 85 | | | | |
| (DUP) | | | | | | |
| Adipate | | | | | 25 | |
| (DTDA) | | | | | | |
| Sebacate | | | | | | 20 |
| (DIDS) | | | | | | |
| ESO | 6 | 6 | 6 | 6 | 6 | 6 |
| additives | 8 | 8 | 8 | 8 | 8 | 8 |
| migration | — | — | — | OK | − | OK |
| brittleness | −30° C. | −40° C. | −30° C. | −20° C. | −25° C. | −30° C. |
| gelling | control | + | = | − | = | = |

It is observed that the formulations D and F have the best migration resistance.

### 2) EXAMPLES OF COMPOSITIONS BASED ON PVC RESINS WITH VARIOUS K-VALUES

Compositions with various PVC resins having K-values ranging from 66 to 80 were prepared according to the following formulae in Table 2 below:

TABLE 2

| | K-value | K-value | K-value |
|---|---|---|---|
| Formula | 80 | 70 | 66 |
| PVC suspension | 100 | 100 | 100 |
| PVC emulsion | 10 | 10 | 10 |
| Polymer | 85 | 85 | 85 |
| plasticizers | | | |
| ESO | 6 | 6 | 6 |
| additives | 8 | 8 | 8 |
| migration | OK | OK | OK |
| brittleness | + | control | − |
| gelling | − | control | + |

No appreciable influence on the migration was observed.

1. A composition based on plasticized polyvinyl chloride (PVC) thermoplastic resins for producing a layer of a composite skin or structure, this layer being equipped with a coating on its outer face, characterized in that it comprises, expressed in weight percent:
from 40 to 60% of one or more PVC resins with a K-value between 50 and 80;
from 30 to 50% of one or more types of plasticizers, said plasticizer comprising a polymeric plasticizer or a heavy monomeric plasticizer; and
from 1 to 20% of an additive selected from the group consisting of pigments, fillers, stabilizers, antioxidants, processing aids and lubricants.

2. The composition as claimed in claim 1, characterized in that said polymeric plasticizer or heavy monomeric plasticizer comprises greater than 10 wt % relative to the total amount of plasticizers.

3. The composition as claimed in claim 1, characterized in that the weight ratio of plasticizers to the resin is at least 60/100.

4. The composition as claimed in claim 1, characterized in that the polymeric plasticizer is selected from polyphthalates or polyadipates.

5. The composition as claimed in claim 1, further comprising a plasticizer, chosen from the group azelates, trimellitates, sebacates, adipates, phthalates, citrates, benzoates, tallates, glutarates, fumarates, maleates, oleates, palmitates or acetates.

6. The composition as claimed in claim 2, characterized in that the heavy monomeric plasticizer has a weight-average molecular weight of at least 350.

7. The composition as claimed in claim 1, characterized in that the thermoplastic resin is polyvinyl chloride (PVC) obtained by a suspension or bulk process.

8. The composition as claimed in claim 1, characterized in that the thermoplastic resin comprises a mixture of polyvinyl chloride (PVC) and a compatible polymer selected from the group consisting of: copolymers or terpolymers of vinyl chloride and vinyl acetate (VC/VA); vinyl chloride and an acrylic derivative (VC/AD); thermoplastic polyurethanes (TPUs); thermoplastic polyetheresters; ethylene/vinyl monomer (EVA) copolymers; ethylene/vinyl monomer/carbonyl terpolymers; melt-processable acrylic elastomers; copolymers with polyamide blocks and polyether blocks or polyether-block-amides; chlorinated or chlorosulfonated polyethylenes; functionalized or unfunctionalized ethylene/alkyl (meth)acrylate or (meth)acrylic acid polymers; MBS core-shell polymers; SBM block terpolymers; PVDF and powdered polyamide resins.

9. The composition as claimed in claim 1, characterized in that the additives are chosen from pigments, fillers, lubricants, UV stabilizers, heat stabilizers, processing aids or antioxidants, in amounts between 3 and 10 wt % relative to the composition.

10. A composite skin or structure comprising the composition of claim 1 wherein the outer surface of said composite skin or structure is covered with a coating chosen from compositions based on epoxy resin, polyurethane resin, PVC or acrylic resins.

11. (canceled)

12. A process for preparing a composite skin structure for a motor vehicle passenger compartment part comprising:
depositing a coating as a first layer in a mold,
forming a second layer by slush molding the composition of claim 1 over said first layer.
